(19) United States
(12) Patent Application Publication
(10) Pub. No.: US 2017/0315289 A1
(43) Pub. Date: Nov. 2, 2017

(54) LIGHT SOURCE ASSEMBLY AND DISPLAY APPARATUS INCLUDING THE SAME

(71) Applicant: Samsung Display Co., Ltd., Yongin-Si (KR)

(72) Inventors: Hanmoe CHA, Seoul (KR); Euijeong KANG, Suwon-si (KR); Hyuk-hwan KIM, Hwaseong-si (KR); Yeongbae LEE, Suwon-si (KR)

(21) Appl. No.: 15/581,766

(22) Filed: Apr. 28, 2017

(30) Foreign Application Priority Data
May 2, 2016 (KR) 10-2016-0054178

(51) Int. Cl. F21V 8/00

(52) U.S. Cl. CPC G02B 6/0026; G02B 6/0068; G02B 6/0088

(57) ABSTRACT

A light source assembly includes a light source board in which a first groove is defined; a light emitting chip which is the first groove and generates light; and a light conversion unit which is in the first groove to overlap the light emitting chip and emit converted light which is provided to a display panel which displays an image with the converted light. The light conversion unit includes a lower substrate in which a second groove is defined to face the light emitting chip; an upper substrate coupled to the lower substrate and in which a third groove is defined; and a wavelength conversion layer which converts the wavelength of the light provided from the light emitting chip and emits the converted light, the wavelength conversion layer in the third groove and between the lower substrate and the upper substrate to overlap the light emitting chip.

This application claims priority to Korean Patent Application No. 10-2016-0054178, filed on May 2, 2016, and all the benefits accruing therefrom under 35 U.S.C. §119, the contents of which in their entirety are hereby incorporated by reference.

### BACKGROUND

### (1) Field

One or more embodiment of the present disclosure relates to a light source assembly and a display apparatus including the same.

### (2) Description of the Related Art

Various display apparatuses such as a liquid crystal display device, an electro wetting display device and an electrophoretic display device are being developed.

In general, display apparatuses include a display panel configured to generate and display an image with light and a backlight configured to provide light to the display panel. The display panel controls transmittance of the light therethrough, provided from the backlight and displays an image with the transmitted light. The light provided from the backlight to the display panel may be white light.

The backlight may be classified into an edge type backlight that provides light from one lateral side of the display panel to the display panel and a direct type backlight that provides light from a lower side of the display panel to the display panel. The edge type backlight includes a light source configured to generate light and a light guide plate configured to guide a direction of the light therethrough. The light guide plate guides the light generated from the light source to the display panel.

### SUMMARY

One or more embodiment provides a display apparatus that reduces or effectively prevents display quality from being deteriorated and is reduced in overall size.

An embodiment of the invention provides a light source assembly including: a light source board in which a first groove is defined; a light emitting chip which is disposed the first groove and generates light; and a light conversion unit which is accommodated in the first groove to overlap the light emitting chip, converts a wavelength of the light provided from the light emitting chip and emits converted light which is provided to a display panel which displays an image with the converted light. The light conversion unit includes: a lower substrate in which a second groove is defined to face the light emitting chip; an upper substrate coupled to the lower substrate and in which a third groove is defined; and a wavelength conversion layer which converts the wavelength of the light provided from the light emitting chip and emits the converted light, the wavelength conversion layer disposed in the third groove and between the lower substrate and the upper substrate to overlap the light emitting chip.

In an embodiment, the lower substrate of the light conversion unit may be accommodated in the first groove defined in the light source board and may have a total thickness greater than a total depth of the first groove.

In an embodiment, the wavelength conversion layer may include a plurality of quantum dots.

In an embodiment, the lower substrate may be accommodated in the first groove defined in the light source board to dispose the second groove of the lower substrate and light emitting chip in the first groove.

In an embodiment, the light emitting chip may emit blue light.

In an embodiment, the first groove may be provided in plurality in the light source board, the light emitting chip may be provided in plurality and respectively accommodated within the first grooves, and the second groove may be defined in plurality in the lower substrate to one-to-one correspond to the light emitting chips accommodated in the first grooves of the light source board.

In an embodiment, the wavelength conversion layer may include: a first wavelength conversion layer including a first quantum dot; and a second wavelength conversion layer including a second quantum dot. The third groove may be defined in plurality in the upper substrate, and the first conversion layer and the second conversion layer are one-to-one correspondingly filled in the third grooves.

In an embodiment, the first quantum dot may have a size greater than that of the second quantum dot.

In an embodiment, the first groove may overlap the second and third grooves.

In an embodiment, the lower substrate may include a first surface which contacts the light source board, and a second surface which is opposite to the first surface and contacts the upper substrate, and the second groove may be defined recessed from the first surface.

In an embodiment, each of the lower substrate and the upper substrate may include a glass material.

In an embodiment of the invention, a display apparatus includes: a display panel which displays an image by using light; and a backlight which generates the light, converts a wavelength of the light and provides converted light to the display panel, the backlight including a light source assembly which generates the light, converts the wavelength of the light and emits the converted light. The light source assembly includes: a light source board in which a first groove is defined; a light emitting chip which is disposed in the first groove and generates the light; and a light conversion unit which is accommodated in the first groove to overlap the light emitting chip, converts the wavelength of the light emitted from the light emitting chip and emits the converted light. The light conversion unit includes: a lower substrate in which a second groove is defined to face the light emitting chip; an upper substrate coupled to the lower substrate and in which a third groove is defined; and a wavelength conversion layer which converts the wavelength of the light provided from the light emitting chip and emits the converted light, the wavelength conversion layer disposed in the third groove and between the lower substrate and the upper substrate to overlap the light emitting chip.

In an embodiment, the lower substrate of the light conversion unit may be accommodated in the first groove defined in the light source board and may have a total thickness greater than a total depth of the first groove.

In an embodiment, the backlight further may include a light guide plate which provides the converted light to the display panel, the light source assembly may be disposed adjacent to one side surface of the light guide plate, and the light source board of the light source assembly may extend along the side surface of the light guide plate to dispose the light conversion unit between the light source board and the side surface of the light guide plate.

In an embodiment, the display apparatus may further include an accommodation member in which the backlight is accommodated. The light source assembly may be provided in plurality, and the plurality of light source assemblies may be arranged on a bottom surface of the accommodation member.

In an embodiment, the lower substrate may be accommodated in the first groove defined in the light source board to dispose the second groove of the lower substrate and the light emitting chip in the first groove.

In an embodiment, the first groove may overlap the second and third grooves.

In an embodiment, the lower substrate may include a first surface which contacts the light source board, and a second surface which is opposite to the first surface and contacts the upper substrate, and the second groove may be defined recessed from the first surface.

In an embodiment, the light conversion layer may include: a first wavelength conversion layer including a first quantum dot; and a second wavelength conversion layer including a second quantum dot. The third groove may be defined in plurality in the upper substrate, and the first wavelength conversion layer and the second wavelength conversion layer may be one-to-one correspondingly filled in the third grooves.

In an embodiment, the first quantum dot may have a size greater than that of the second quantum dot.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain principles of the invention. In the drawings:

FIG. 1 is an exploded perspective view of an exemplary embodiment of a display apparatus according to the invention;

FIG. 2 is a cross-sectional view taken along line I-I′ of FIG. 1;

FIG. 3 is an enlarged perspective view of an exemplary embodiment of a light source assembly of the display apparatus illustrated in FIG. 1;

FIG. 4 is a cross-sectional view taken along line II-II′ of FIG. 3;

FIG. 5 is an exploded perspective view of an exemplary embodiment of a light conversion unit of the light source assembly illustrated in FIG. 3;

FIG. 6 is a cross-sectional view of another exemplary embodiment of a light source assembly according to the invention;

FIG. 7 is a cross-sectional view of still another exemplary embodiment of a light source assembly according to the invention; and

FIG. 8 is an exploded perspective view of another exemplary embodiment of a display apparatus according to the invention.

### DETAILED DESCRIPTION

Advantages and features of the present disclosure, and implementation methods thereof will be clarified through following embodiments described in detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the invention to those skilled in the art. Further, the present disclosure is only defined by scopes of claims. Like reference numerals refer to like elements throughout.

When an element or layer is referred to as being “on” another element or layer, it can be directly on the other element or layer, or intervening elements or layers may also be present. In contrast, when an element is referred to as being “directly on” another element, there are no intervening elements or layers present. The term “and/or” includes any and all combinations of one or more of the associated listed items.

Spatially relative terms, such as “below,” “beneath,” “lower,” “above,” “upper” and the like, may be used herein for ease of description to describe one element or feature's relationship to another element(s) or feature(s) as illustrated in the figures. The spatially relative terms should be understood as terms which include different directions of elements in addition to directions illustrated in the figures when using or operating the invention.

It will be understood that although the terms first, second, etc. may be used herein to describe various elements, components, and/or sections, these elements, components, and/or sections should not be limited by these terms. These terms are only used to distinguish one element, component, or section from another element, component, or section. Accordingly, a first element, a first component, or a first section that will be described below may be a second element, a second component, or a second section within the technical idea of the present disclosure.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The embodiments in this specification will be described with schematic plan views and cross-sectional views as ideal exemplary views of the present disclosure. Accordingly, shapes of the exemplary views may be modified according to manufacturing techniques and/or allowable errors. Therefore, the embodiments of the invention are not limited to the specific shapes illustrated in the exemplary views, but may include other shapes that are created according to manufacturing processes. Thus, areas exemplified in the drawings have general properties, and shapes of the areas are used to illustrate a specific shape of a device region. Thus, this should not be construed as limited to the scope of the present disclosure.

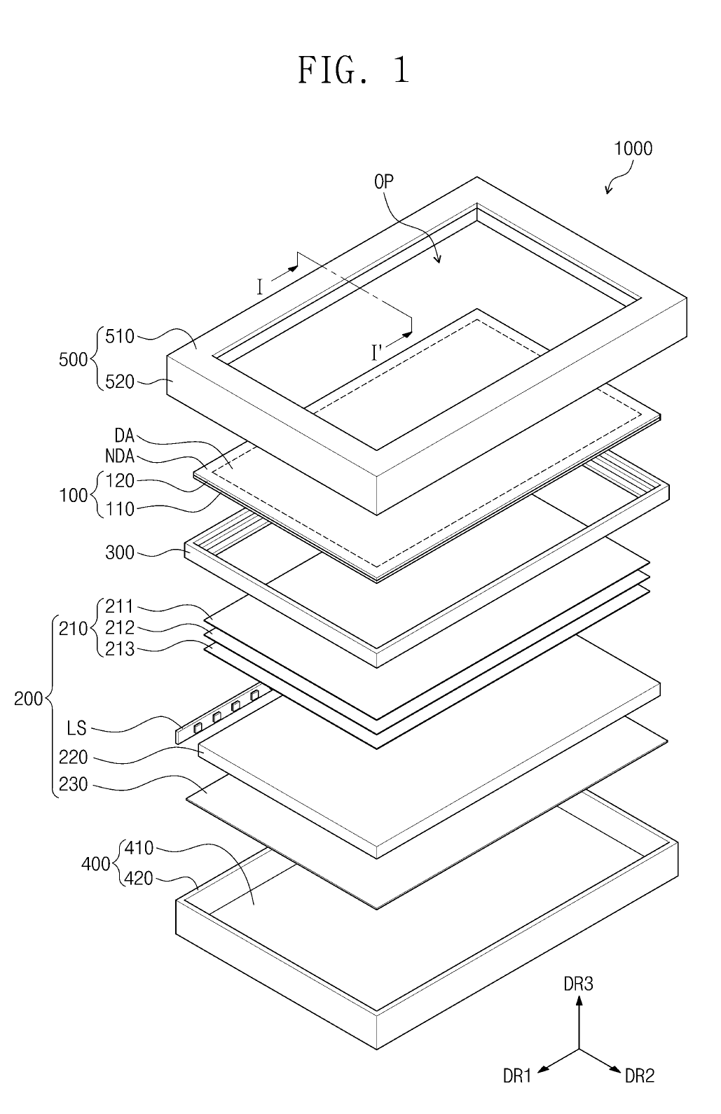

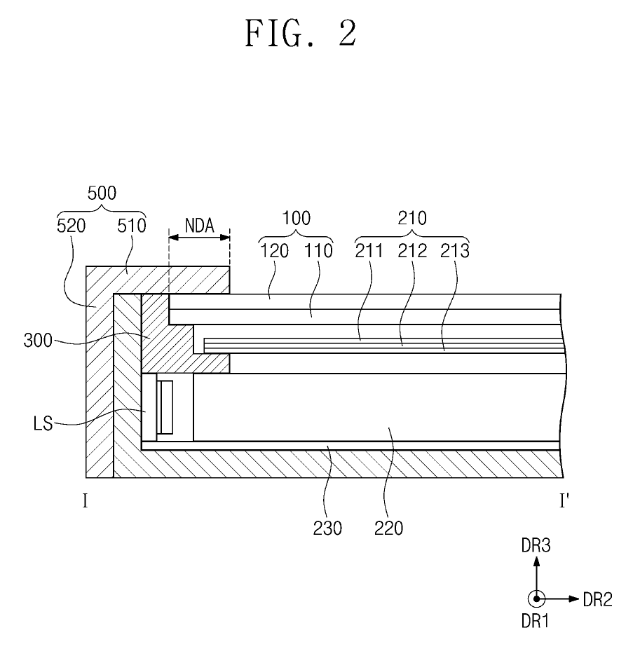

FIG. 1 is an exploded perspective view of an exemplary embodiment of a display apparatus according to the invention, and FIG. 2 is a cross-sectional view taken along line I-I′ of FIG. 1.

Referring to FIGS. 1 to 2, an embodiment of a display apparatus 1000 according to the invention includes a display panel 100, a backlight 200, a mold frame 300, and an accommodation member 400 and a cover member 500.

According to the embodiment, the display panel 100 may be a liquid crystal display panel, but the invention is not limited thereto. That is, the display panel 100 may include a display substrate 110 in which a plurality of pixels (not shown) that use light provided from the backlight 200 to generate and display an image are disposed, and an opposite substrate 120 disposed to face the display substrate 110. Although not shown, the display panel 100 may include an optical medium layer such as a liquid crystal layer (not shown) disposed between the display substrate 110 and the opposite substrate 120.

The display panel 100 includes or defines a display area DA at which the pixels (not shown) are disposed and a non-display area NDA which is disposed around the display area DA in a top plan view thereof. Also, the display panel 100 displays an image through the display area DA and may not display the image at the non-display area NDA. The display area DA of the display panel 100 may define the display area of the display apparatus 1000. The non-display area of the display panel 100 may define a portion of the non-display area of the display apparatus 1000, for which a remainder of the non-display area thereof is extended to an outer edge of the display apparatus 1000.

The backlight 200 may be disposed at a rear side of the display panel 100 to generate light and provide the light to the display panel 100. The backlight 200 may be an edge type backlight, but the invention is not limited thereto.

The backlight 200 includes a light source assembly LS, an optical sheet 210, and a light guide plate 220 and a reflection sheet 230.

Each of the display panel 100, the optical sheet 210, the light guide plate 220 and the reflection sheet 230 has a long side lengthwise extended in a first direction DR1 and a short side lengthwise extended in a second direction DR2 crossing the first direction DR1. A bezel of the display apparatus 1000 may be extended in a plane defined by the first and second directions DR1 and DR2. The bezel of the display apparatus 1000 may correspond to the non-display area of the display apparatus 1000. Referring to FIG. 2, the bezel of the display apparatus 1000 may include a dimension of the non-display area NDA of the display panel 100 in the second direction DR2, and a remaining dimension of the cover member 500 in the second direction DR2 to an outer surface of the cover member 500.

According to the embodiment of the invention, the light source assembly LS is disposed to be adjacent in the second direction DR2 to a side of the light guide plate 220. The reflection sheet 230 may be disposed under the light guide plate 220, and the optical sheet 210 may be disposed above the light guide plate 220, with reference to a thickness direction of the display apparatus 1000. The display panel 100 is disposed above the optical sheet 220.

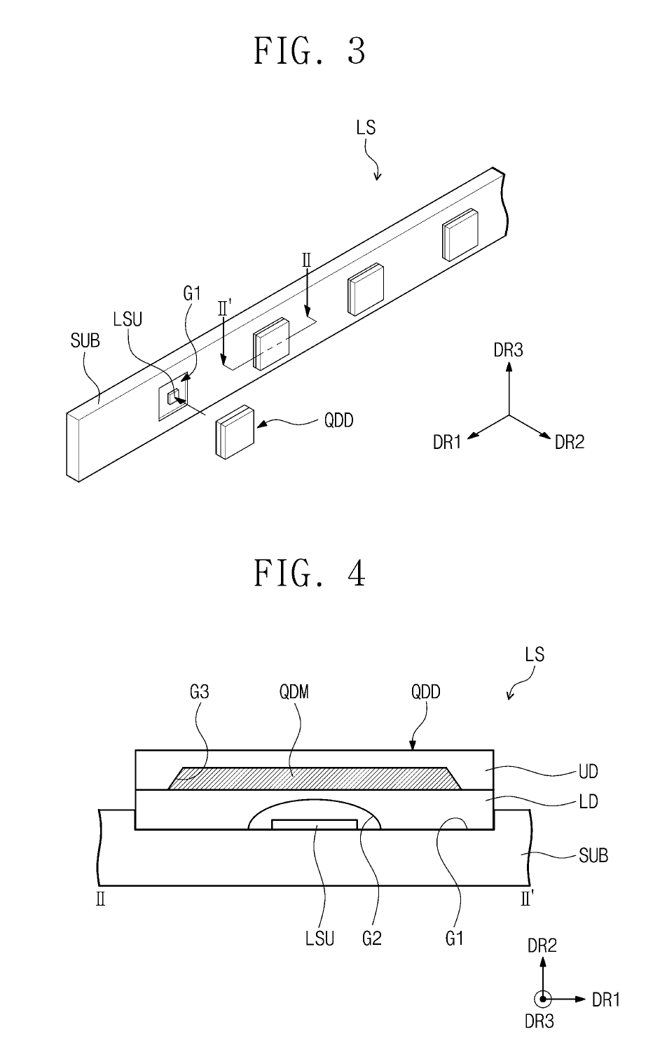

The light source assembly LS generates light to be provided to the display panel 100 and then provides the light to the light guide plate 220. The light, that is emitted from the light source assembly LS and provided to the light guide plate 220, may be white light. According to the embodiment of the invention, the light source assembly LS lengthwise extends in the first direction DR1 along the side of the light guide plate 220. This light source assembly LS will be described in detail with reference to FIGS. 3 to 5.

The light guide plate 220 may have a plate shape. The light guide plate 220 may change a traveling direction of the light provided from the light source units LSU so that the light is emitted in an upward direction in which the display panel 100 is disposed relative to the light guide plate 220. Although not shown, the light guide plate 220 may have patterns, grooves, and the like defined at a bottom surface of the light guide plate 220 to scatter the light incident thereto. In addition, the light guide plate 220 may have a top (e.g., emitting) surface in which a lens shape or a pattern such as a groove is formed. Side surfaces of the light guide plate 220 connect the bottom and top surfaces to each other.

The light guide plate 220 includes a material having relatively high light transmittance in the visible light region. In an embodiment, for example, the light guide plate 220 may include polymethylmethacrylate (“PMMA”).

The optical sheet 210 may be disposed between the light guide plate 200 and the display panel 100. The light emitted from the light guide plate 220 to the optical sheet 210 may be diffused and collected through the optical sheet 210 and be provided to the display panel 100. The optical sheet 210 may collectively include a diffusion sheet 211, a prism sheet 212, and a protection sheet 213.

The reflection sheet 230 is disposed under the light guide plate 220. The reflection sheet 230 reflects light, which is emitted to a lower side of the light guide plate 220, in an upward direction. The reflection sheet 230 includes a light reflecting material. In an embodiment, for example, the reflection sheet 230 may include aluminum.

The mold frame 300 is disposed above the light guide plate 220. According to the embodiment, the mold frame 300 has a frame shape. Particularly, the mold frame 300 may be disposed to correspond to an edge area at a top surface of the light guide plate 220. The mold frame 300 performs a function of fixing the display panel 100 and the backlight 200 to each other.

The mold frame 300 has a cross-section having a stair or stepped shape. Particularly, the stair shape of the mold frame 300 may define a plurality of planes disposed inside the frame shape of the mold frame 300. The planes may extend in horizontal directions defined by directions including the first direction DR1 and the second direction DR2, and the planes adjacent to each other may have a stepped portion therebetween in the thickness direction.

The display panel 100 and the optical sheet 210 may be respectively seated on the planes disposed inside the mold frame 300. Thus, since the mold frame 300 has the stepped portions, the display panel 100 and the optical sheet 210 may be disposed to be spaced apart from each other.

The accommodation member 400 includes a bottom portion 410 and a sidewall 420 which is provided in plurality each connected to the bottom portion 410. The accommodation member 400 is disposed on the lowermost end of the display apparatus 1000 to accommodate the backlight 200 therein. According to the embodiment of the invention, the light source assembly LS may be disposed on an inner surface of a sidewall 420 of the accommodation member 400. The accommodation member 400 may include a metal material having rigidity.

The cover member 500 is disposed above the display panel 100. The cover member 500 has a frame shape. The cover member 500 includes a first cover portion 510 configured to cover the non-display area NDA above the display panel 100, a second cover portion 520 configured to define a sidewall of the cover member 500, and an opening portion OP disposed at the inside of the first cover portion 510 to expose the display area DA of the display panel 100 thereunder. The second cover portion 520 may be provided in plurality to define a plurality of sidewalls of the cover member 500.

The second cover portion 520 is connected to the outside of the first cover portion 510 and extends downward. That is, the first cover portion 510 and the second cover portion 520 may be disposed to be perpendicular to each other. The second cover portion 520 is disposed to surround outer surfaces of the accommodation member 400.

FIG. 3 is an enlarged view of an exemplary embodiment of the light source assembly of the display apparatus illustrated in FIG. 1.

Referring to FIG. 3 in more detail, the light source assembly LS includes a light source board SUB, a light emitting chip LSU provided in plural, and a light conversion unit QDD provided in plural.

The light source board SUB lengthwise extends in the first direction DR1. A thickness of the light source board SUB extends in the second direction DR2. The light source board SUB is disposed to face a side surface (e.g., incident surface) of the light guide plate 220. The light source board SUB may provide a power and/or signal to the light emitting chip LSU such that the light emitting chip LSU generates light. The light source board SUB may have a top surface parallel with a plane defined by the first direction DR1 and a third direction DR3. Here, the third direction DR3 is defined as a direction perpendicular to both of the first direction DR1 and the second direction DR2. Also, the third direction DR3 is regarded as a reference direction to distinguish a front surface with a rear surface or an upper portion with a lower portion in each of members described later.

A groove G1 provided in plural are defined in the light source board SUB. The first grooves G1 are defined to be recessed from the top surface of the light source board SUB in a direction opposite to the second direction DR2. The first grooves G1 may be disposed spaced apart from each other at an interval in the first direction DR1.

The light emitting chips LSU may be accommodated in one-to-one correspondence with the first grooves G1 and fixed to the light source board SUB. Particularly, the light emitting chips LSU are disposed on bottom surfaces of the first grooves G1. Each of the light emitting chips LSU may be a blue light emitting diode (“LED”) configured to generate blue light.

The light conversion units QDD are accommodated in one-to-one correspondence with the first grooves G1 to cover the light emitting chips LSU, respectively. Each of the first grooves G1 may be a coupling groove at which the light conversion unit QDD is fixed within the light source assembly LS. Each of the light conversion units QDD has a size and shape in the plane defined by the first direction DR1 and the third direction DR3, which correspond to a size and shape of each of the first grooves G1 on the same plane.

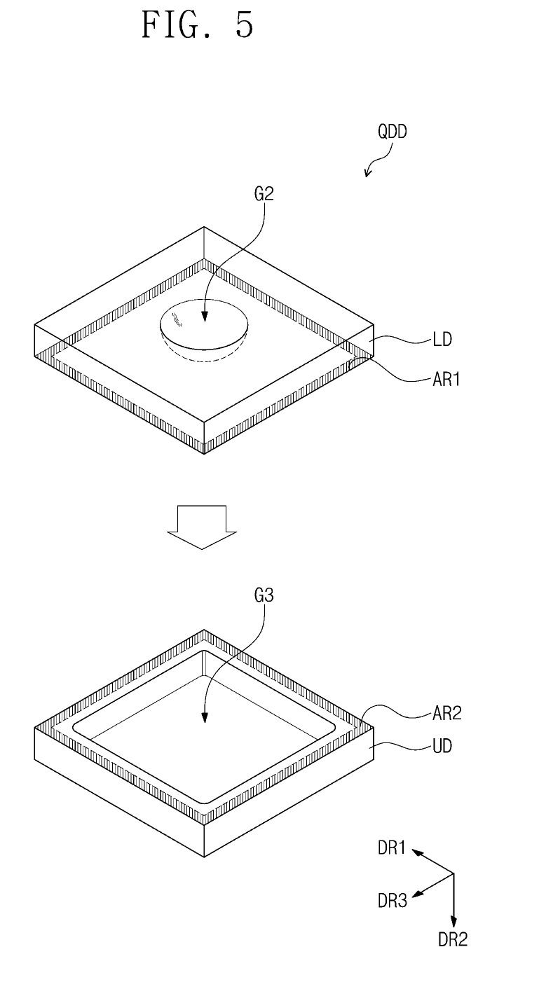

The light conversion units QDD perform a function of converting wavelengths of light incident thereto provided from the light emitting chips LSU. This light conversion unit QDD will be described in detail with reference to FIGS. 4 to 5.

According to the embodiment of the invention, the plurality of first grooves G1 are defined in the light source board SUB so that the plurality of light emitting chips LSU are respectively accommodated in the first grooves G1. However, the embodiment of the invention is not limited to the number of the first grooves G1 and the light emitting chips LSU described above. In an exemplary embodiment, for example, only one first groove G1 may be defined in the light source board SUB so that only one light emitting unit LSU is accommodated in the only one first groove G1.

FIG. 4 is a cross-sectional view taken along line II-II′ of FIG. 3, and FIG. 5 is an exploded perspective view of an exemplary embodiment of the light conversion unit of the light source assembly illustrated in FIG. 3. FIG. 5 illustrates a state in which the light conversion unit QDD is overturned to show a rear surface thereof for convenience in description.

Referring to FIGS. 4 and 5, each of the light conversion units QDD has a tetragonal chip shape. However, the embodiment of the invention is not limited to shapes of the light conversion units QDD described herein. In another exemplary embodiment, for example, the light conversion units QDD may have various shapes including a circular shape.

Each of the light conversion units QDD includes a lower substrate LD, an upper substrate UD, and a wavelength conversion layer QDM. The lower substrate LD is coupled to the upper substrate UD to form one body. Each of the lower substrate LD and the upper substrate UD may be manufactured by an injection-molding, a compression-molding, an extrusion-molding, and the like. The wavelength conversion layer QDM is disposed between the lower substrate LD and the upper substrate UD.

Each of the lower substrate LD and the upper substrate UD has relatively high light transmissivity. In an exemplary embodiment, for example, each of the lower substrate LD and the upper substrate UD may include a transparent glass material.

The lower substrate LD is accommodated in the first groove G1 of the light source board SUB. In planes defined by the first and third directions DR1 and DR3, the lower substrate LD includes a first surface and a second surface which is opposite to the first surface.

The first surface contacts a bottom surface of the first groove G1 defined in the light source board SUB. The first surface may be attached to the bottom surface of the first groove G1 by adhesion member (not shown). The adhesion member may be an adhesion tape or adhesive including a polymer material.

A second groove G2 is defined at the first surface of the lower substrate LD. In the first and/or third direction DR1 and DR3, the second groove G2 may have a width less than that of the first groove G1. The second groove G2 overlaps a position at which the light emitting chip LSU is disposed on a plane. The second groove G2 performs a function of covering the light emitting chip LSU. That is, the light emitting chip LSU may be accommodated within a space defined by the first groove G1 and the second groove G2.

According to the embodiment of the invention, the second groove G2 has an arch shape recessed upward in the second direction DR2 from the first surface. However, the embodiment of the invention is not limited to the shapes of the second groove G2. In exemplary embodiments, for example, the second groove G2 may have various shapes such as a column shape, a hemispherical shape, a pyramid shape, and the like.

A total thickness of the lower substrate LD in the second direction DR2 is greater than a depth of the first groove G1 in the second direction DR2. Thus, only the first surface of the lower substrate LD may be accommodated in the first groove G1, while the second surface of the lower substrate LD is disposed outside the first groove G1.

In planes defined by the first and third directions DR1 and DR3, the upper substrate UD includes a third surface and a fourth surface which is opposite to the third surface. The third surface may contact the second surface of the lower substrate LD. Particularly, a first adhesion area AR1 is defined at an edge area of the second surface of the lower substrate LD, and a second adhesion area AR2 is defined at an edge area of the third surface of the upper substrate UD. The first adhesion area AR1 overlaps the second adhesion area AR2. Since the second surface having the first adhesion area AR1 is adhered to the third surface having the second adhesion area AR2, the lower substrate LD may be coupled to the upper substrate UD.

The lower substrate LD may be attached to the upper substrate UD by a sealant (not shown). The sealant includes a transparent material. In an exemplary embodiment, for example, the sealant may include glass or a polymer. In an embodiment of manufacturing a display apparatus according to the invention, frit including glass powder is applied on the first adhesion area AR1 and/or the second adhesion area AR2 to couple the lower substrate LD to the upper substrate UD.

A third groove G3 is defined at the third surface of the upper substrate UD. The second adhesion area AR2 is defined to surround the third groove G3. In the first and/or third direction DR1 and DR3, the third groove G3 has a width greater than that of the second groove G2. The third groove G3 overlaps a position at which the light emitting chip LSU is disposed on a plane.

The third groove G3 may be filled with the wavelength conversion layer QDM. Particularly, the wavelength conversion layer QDM may be filled in a space defined by the third groove G3 and the second surface of the lower substrate LD.

The wavelength conversion layer QDM includes a plurality of quantum dots (not shown). The quantum dots convert a wavelength band of light incident thereto and mix light having wavelength bands different from each other to emit the mixed light.

When the quantum dots decrease in sizes, light having a short wavelength is generated. On the other hand, when the quantum dots increase in sizes, light having a long wavelength is generated. The above-described phenomenon is defined as the quantum size effect. In the embodiment, the wavelength conversion layer QDM may include the quantum dots having various sizes. As a result, light having various wavelength bands may be emitted from the wavelength conversion layer QDM.

According to the embodiment of the invention, light emitted from the light conversion unit QDD may be white light. Particularly, the blue light generated in the light emitting chip LSU passes through the lower substrate LD, and then is provided to the wavelength conversion layer QDM. The quantum dots of the wavelength conversion layer QDM absorb the light, and then convert a portion of the light into light having a green or red wavelength band. As a result, light having a blue, green and red wavelengths are mixed with each other to realize the white light.

The fourth surface of the upper substrate UD may be an emission surface. The light converted by the wavelength conversion layer QDM is emitted through the fourth surface, and then provided to the light guide plate 220.

According to the embodiment of the invention, the light conversion unit QDD is coupled to the first groove G1 and fixed to the light source board SUB. Therefore, misalignment of the light conversion unit QDD with respect to the light emitting chip LSU may be reduced or effectively prevented. Also, the light conversion unit QDD may be easily assembled within the light source assembly LS owing to the first groove G1 in which the light conversion unit QDD is accommodated.

Also, according to the embodiment of the invention, a portion of the lower substrate LD of the light conversion unit QDD is accommodated in the first groove G1 of the light source board SUB. Thus, in the display apparatus 1000, a thickness in the second direction occupied by the light conversion units QDD may be reduced owing to the light conversion units QDD overlapping the light source board SUB in the second direction DR2.

Also, the light emitting chip LSU is accommodated in the second groove G2 of the lower substrate LD to compensate a thickness occupied by the light emitting chip LSU in the display apparatus 1000. As a result since the light source board SUB, the light conversion unit QDD and the light emitting chip LSU overlap each other in the second direction, a bezel of the display panel 1000 may be reduced in size.

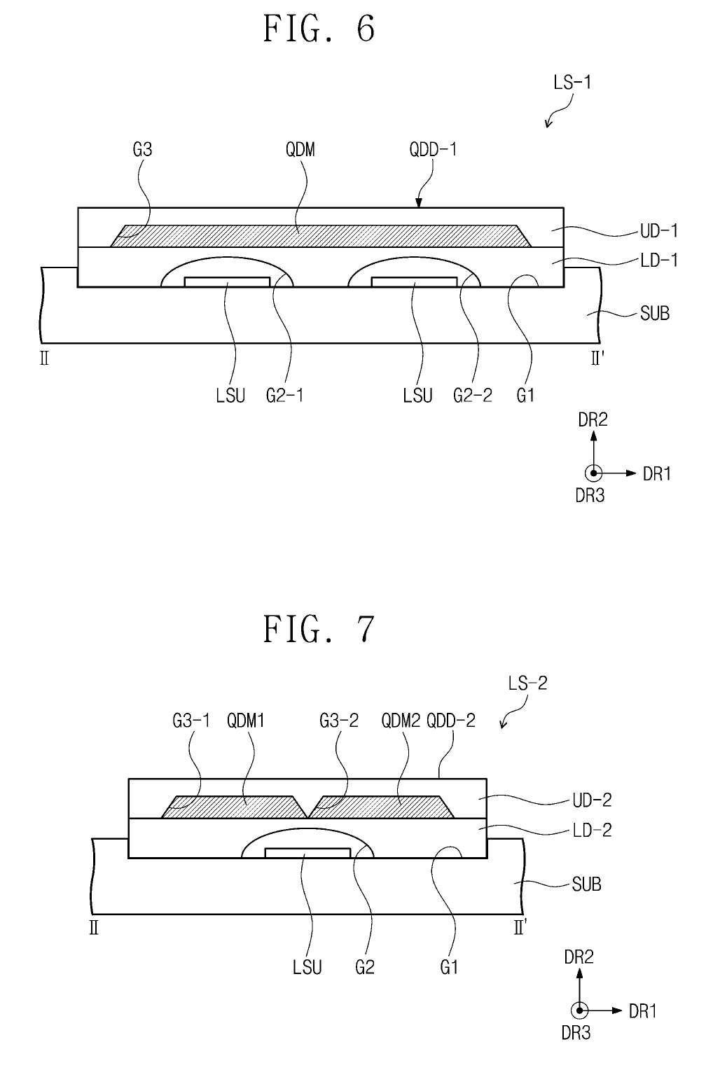

FIG. 6 is a cross-sectional view of another exemplary embodiment of a light source assembly LS-1 according to the invention. In description of FIG. 6, the same reference symbols are given to the same components, and duplicated descriptions with respect to the components will be omitted.

According to another embodiment of the invention in reference with FIG. 6, two light emitting chips LSU may be accommodated in a same first groove G1 of the light source board SUB. That is, the first groove G1 may be commonly disposed relative to the two light emitting chips LSU. The light emitting chips LSU are arranged spaced apart from each other in the first direction DR1 and disposed on the bottom surface of the common first groove G1.

Also, according to the embodiment, two second grooves G2-1 and G2-2 may be defined in a lower substrate LD-1 of a light conversion unit QDD-1. The second grooves G2-1 and G2-2 one-to-one correspondingly overlap the light emitting chips LSU. The second grooves G2-1 and G2-2 cover the light emitting chips LSU, respectively.

Although two light emitting chips LSU and two second grooves G2 are exemplified in the embodiment, the invention is not limited thereto. In another embodiment, for example, according to the invention, three or more light emitting chips LSU may be accommodated in a common first groove G1, and the second grooves G2 that one-to-one correspond to the light emitting chips LSU may be defined in the lower substrate LD-1.

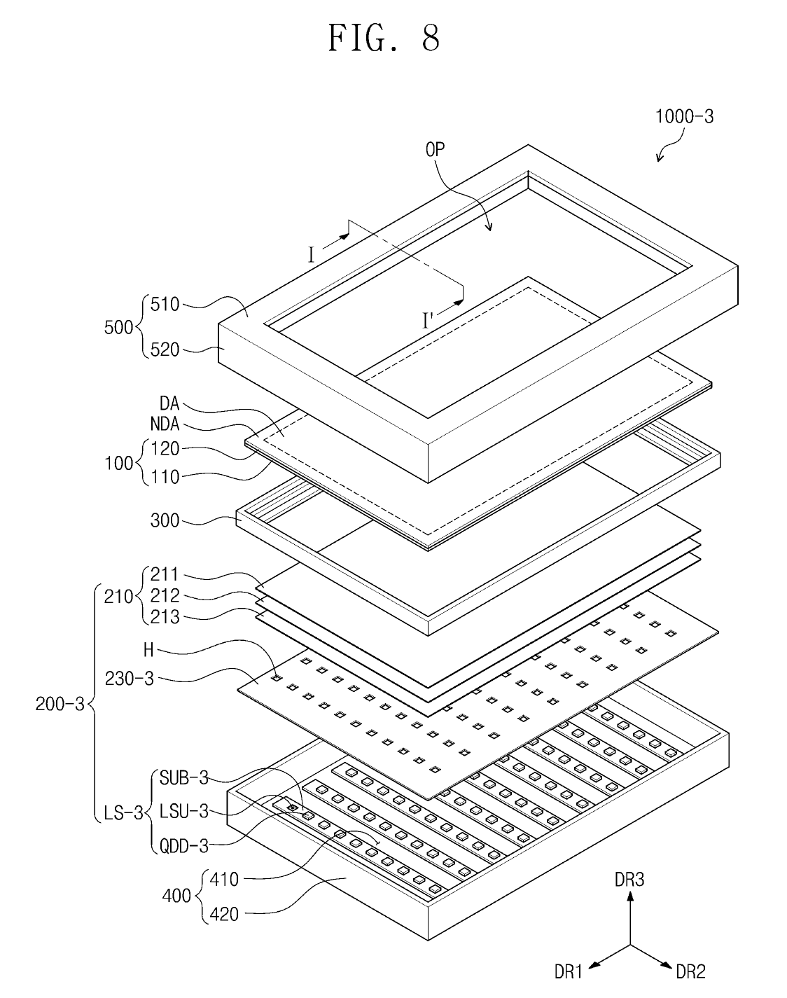

FIG. 7 is a cross-sectional view of still another exemplary embodiment of a light source assembly LS-2 according to the invention. In description of FIG. 7, the same reference symbols are given to the same components, and duplicated descriptions with respect to the components will be omitted.

Referring to FIG. 7, a light conversion unit QDD-2 according to another embodiment of the invention includes a lower substrate LD-2, an upper substrate UD-2, a first wavelength conversion layer QDM1 and a second wavelength conversion layer QDM2.

The first wavelength conversion layer QDM1 includes a plurality of first quantum dots. The second wavelength conversion layer QDM2 includes a plurality of second quantum dots. In the embodiment of the invention, each of the first quantum dots may have a size greater than that of each of the second quantum dots.

According to the embodiment, two third grooves G3-1 and G3-2 are defined in the upper substrate LD-2. The first wavelength conversion layer QDM1 and the second wavelength conversion layer QDM2 may be one-to-one correspondingly filled in the third grooves G3-1 and G3-2.

Therefore, light emitted from a common light emitting chip LSU passes through the lower substrate LD-2 and then is provided to each of the first wavelength conversion layer QDM1 and the second wavelength conversion layer QDM2. When the blue light is emitted from the light emitting chip LSU, a portion of light which is provided to the first wavelength layer QDM1, of the light provided to the light conversion unit QDD-2 is absorbed to the first quantum dots and then converted into light having the red wavelength band and emitted from the light conversion unit QDD-2. Similarly, another portion of light, which is provided to the second wavelength layer QDM2, of the light provided to the light conversion unit QDD-2 is absorbed to the second quantum dots and then converted into light having the green wavelength band and emitted from the light conversion unit QDD-2.

Although the blue light is converted into the light having the red wavelength band and the light having the green wavelength band by the first quantum dots and the second quantum dots, respectively in the embodiment, the invention is not limited thereto. In another exemplary embodiment, for example, according to the invention, light having various colors in addition to the red and green colors may be easily generated depending on sizes of the first and second quantum dots within the light conversion unit QDD-2.

Also, according to the embodiment, the light conversion unit QDD-2 includes two wavelength conversion layers QDM1 and QDM2. However, according to another embodiment, three or more third grooves G3 are defined in the upper substrate UD so that three or more wavelength conversion layers are one-to-one correspondingly filled in the third grooves G3. Also, according to another embodiment, the two wavelength conversion layers QDM1 and QDM2 described may be alternately filled into the three or more third grooves G3.

FIG. 8 is an exploded perspective view of another exemplary embodiment of a display apparatus according to the invention. In description of FIG. 8, the same reference symbols are given to the same components, and duplicated descriptions with respect to the components will be omitted.

Referring to FIG. 8, an embodiment of a backlight 200-3 of a display apparatus 1000-3 according to the invention may be a direct type backlight. That is, in the embodiment, the described-above light guide plate 220 may be omitted in the display apparatus 1000-3 including the direct type backlight 200-3.

The backlight 200-3 includes the optical sheet 210, and a reflection sheet 230-3, and a light source assembly LS-3 provided in plurality.

The plurality of light source assemblies LS-3 are disposed on the bottom portion 410 of the accommodation member 400. The light source assemblies LS-3 may collectively include light source boards SUB-3, which each lengthwise extend in the second direction DR2 and are arranged at a constant interval in the first direction DR1. However, the embodiment of the invention is not limited to a configuration in which the light source boards SUB-3 are arranged as described above. In an alternative embodiment, for example, the light source boards SUB-3 may lengthwise extend in the first direction DR1 and be arranged at a constant interval in the second direction DR2.

The reflection sheet 230-3 is disposed above the light source boards SUB-3. The refection sheet 230-3 includes a hole H provided in plurality. The holes H may be arranged in a matrix form. A light conversion unit QDD-3 provided in plurality of the light source assemblies LS-3 are inserted into the holes H of the reflection sheet 230-3, respectively.

According to the embodiment, a portion of the light conversion unit QDD-3 is accommodated in a first groove G1 (refer to FIGS. 4 through 6). In a thickness direction (e.g., third direction DR3) of the display apparatus 1000-3, the light conversion unit QDD-3 overlaps an upper substrate UD (refer to FIGS. 4 through 6) of the light source assemblies LS-3. Thus, in the display apparatus 1000-3, since the light conversion unit QDD-3 overlaps the upper substrate UD of the light source assemblies LS-3 in the thickness direction, a thickness occupied by the light conversion units QDD-3 may be reduced. That is, the overall thickness of the display apparatus 1000-3 is reduced.

Also, a light emitting chip LSU-3 is accommodated in a second groove G2 in a lower substrate LD (refer to FIGS. 4 through 6) of the light conversion unit QDD-3 to compensate a thickness occupied by the light emitting chip LSU in the display apparatus 1000-3. As a result, since the light emitting chip LSU-3 overlaps the lower substrate LD of the light source assemblies LS-3 in the thickness direction, a thickness occupied by the light conversion units QDD-3 in the display panel 1000 may be reduced. That is, the overall thickness of the display apparatus 1000-3 is reduced.

Therefore, according to one or more embodiment of the invention, the light source assembly may be relatively easily assembled, and misalignment of the light conversion unit within the display apparatus may be reduced or effectively prevented to in turn reduce or effectively prevent the display quality of the display apparatus from being deteriorated. In addition, the display apparatus may be reduced in overall size, both in a planar direction and in a thickness direction thereof

According to one or more embodiment of the invention, deterioration of the display quality of the display apparatus may be reduced or effectively prevented, and the display apparatus may be reduced in overall size.

Although exemplary embodiments of the present disclosure have been described, it is understood that various changes and modifications can be made by one ordinary skilled in the art within the spirit and scope of the present disclosure as hereinafter claims. Also, the embodiments disclosed in the present disclosure are not intended to limit the technical ideas of the present disclosure and all technical ideas within the following claims and their equivalents should be interpreted to be included in the scope of right in the present disclosure.

What is claimed is:

1. A light source assembly comprising:
a light source board in which a first groove is defined;
a light emitting chip which is disposed the first groove and generates light; and
a light conversion unit which is accommodated in the first groove to overlap the light emitting chip, converts a wavelength of the light provided from the light emitting chip and emits converted light which is provided to a display panel which displays an image with the converted light,
wherein the light conversion unit comprises:
a lower substrate in which a second groove is defined to face the light emitting chip;
an upper substrate coupled to the lower substrate and in which a third groove is defined; and
a wavelength conversion layer which converts the wavelength of the light provided from the light emitting chip and emits the converted light, the wavelength conversion layer disposed in the third groove and between the lower substrate and the upper substrate to overlap the light emitting chip.

2. The light source assembly of claim 1, wherein the lower substrate of the light conversion unit is accommodated in the first groove defined in the light source board and has a total thickness greater than a total depth of the first groove.

3. The light source assembly of claim 1, wherein the wavelength conversion layer comprises a plurality of quantum dots.

4. The light source assembly of claim 1, wherein the lower substrate is accommodated in the first groove defined in the light source board to dispose the second groove of the lower substrate and the light emitting chip in the first groove.

5. The light source assembly of claim 1, wherein the light emitting chip emits blue light.

6. The light source assembly of claim 1, wherein
the first groove is provided in plurality in the light source board,
the light emitting chip is provided in plurality respectively accommodated within the first grooves, and
the second groove is defined in plurality in the lower substrate to one-to-one correspond to the light emitting chips accommodated in the first grooves of the light source board.

7. The light source assembly of claim 1, wherein
the wavelength conversion layer comprises:
a first wavelength conversion layer comprising a first quantum dot; and
a second wavelength conversion layer comprising a second quantum dot,
the third groove is defined in plurality in the upper substrate, and
the first conversion layer and the second conversion layer are one-to-one correspondingly filled in the third grooves.

8. The light source assembly of claim 7, wherein the first quantum dot has a size greater than that of the second quantum dot.

9. The light source assembly of claim 1, wherein the first groove overlaps the second and third grooves.

10. The light source assembly of claim 1, wherein
the lower substrate includes a first surface which contacts the light source board, and a second surface which is opposite to the first surface and contacts the upper substrate, and
the second groove is defined recessed from the first surface.

11. The light source assembly of claim 1, wherein each of the lower substrate and the upper substrate comprises a glass material.

12. A display apparatus comprising:
a display panel which displays an image by using light; and
a backlight which generates the light, converts a wavelength of the light and provides converted light to the display panel,
the backlight comprising a light source assembly which generates the light, converts the wavelength of the light and emits the converted light,
wherein the light source assembly comprises:
a light source board in which a first groove is defined;
a light emitting chip which is disposed in the first groove and generates the light; and
a light conversion unit which is accommodated in the first groove to overlap the light emitting chip, converts the wavelength of the light emitted from the light emitting chip and emits the converted light,
wherein the light conversion unit comprises:
a lower substrate in which a second groove is defined to face the light emitting chip;
an upper substrate coupled to the lower substrate and in which a third groove is defined; and
a wavelength conversion layer which converts the wavelength of the light provided from the light emitting chip and emits the converted light, the wavelength conversion layer disposed in the third groove and between the lower substrate and the upper substrate to overlap the light emitting chip.

13. The display apparatus of claim 12, wherein the lower substrate of the light conversion unit is accommodated in the first groove defined in the light source board and has a total thickness greater than a total depth of the first groove.

14. The display apparatus of claim 12, wherein
the backlight further comprises a light guide plate which provides the converted light to the display panel,
the light source assembly is disposed adjacent to a side surface of the light guide plate, and
the light source board of the light source assembly extends along the side surface of the light guide plate to dispose the light conversion unit between the light source board and the side surface of the light guide plate.

15. The display apparatus of claim 12, further comprising an accommodation member in which the backlight is accommodated,
wherein
the light source assembly is provided in plurality within the accommodation member, and
the plurality of light source assemblies are arranged on a bottom surface of the accommodation member.

16. The display apparatus of claim 12, wherein the lower substrate is accommodated in the first groove defined in the light source board to dispose the second groove of the lower substrate and the light emitting chip in the first groove.

17. The display apparatus of claim 12, wherein the first groove overlaps the second and third grooves.

18. The display apparatus of claim 12, wherein
the lower substrate includes a first surface which contacts the light source board, and a second surface which is opposite to the first surface and contacts the upper substrate, and
the second groove is defined recessed from the first surface.

19. The display apparatus of claim 12, wherein
the light conversion layer comprises:
a first wavelength conversion layer comprising a first quantum dot; and
a second wavelength conversion layer comprising a second quantum dot,
the third groove is defined in plurality in the upper substrate, and
the first wavelength conversion layer and the second wavelength conversion layer are one-to-one correspondingly filled in the third grooves.

20. The display apparatus of claim 19, wherein the first quantum dot has a size greater than that of the second quantum dot.
